(19) United States
(12) Patent Application Publication
(10) Pub. No.: US 2008/0276810 A1
(43) Pub. Date: Nov. 13, 2008

(54) Apparatus for pre-shaping dough balls

(76) Inventors: Albert M. Ceja, Upland, CA (US); Efren Navarro, Rialto, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 11/801,926

(22) Filed: May 11, 2007

(51) Int. Cl. A21C 11/00

(52) U.S. Cl. 99/485

(57) ABSTRACT

An automated machine for pre-shaping dough balls in a high speed tortilla machine. A main frame contains a holding press plate with a set of regularly distributed openings, and where a press box is located over the regular openings. Each press box contains a catching ball tube, and a press gate. Each dough ball is sequentially deposited onto a pre-shaper catching ball tube to permit balls to pass through open press gates and onto the surface of a transport band, where they are kept in a predetermined position. Once all of the dough balls reach a predetermined location, they are pre-pressed in place by means of a set of press gates. The flattener press gates close the ball entrance in the catching ball tubes to prevent dough balls entering any further into the press boxes. The press gate devices are actuated to open the catching ball tube and separate the pressing gate device from the pre-pressed balls. The transport band advances the pre-pressed balls towards the main press area. The main frame lowers its position towards the transport band.

### BACKGROUND OF THE INVENTION

1. Field of the Invention

The present invention relates to a device to pre-shape dough balls in sequence so that the shaped dough balls can be subsequently processed in a press and a tortilla-cooking oven.

2. Background of the Invention

The popularity of wheat flour tortillas in the US market has increased 25% over the last 5 years. This situation has exerted continuous pressure on tortilla producers to increase their productivity. Improvement of efficiency in tortilla machines is needed to meet the demand, and thus, faster tortilla producing machines are required.

In the prior art, the tortillas are in the shape of thin, round disks of dough before entering the cooking oven. People versed in the art of bakery know that, in order to form thin, round pieces of dough, spherical portions of the dough must be prepared in advance. Then, two hot flat surfaces compress opposing sides of the pieces in order to obtain the desired thickness. A description of several rounding methods is disclosed in U.S. Pat. No. 4,427,357. U.S. Pat. Nos. 4,668,524, 5,396,833, and 6,015,584 disclose several methods for pre-shaping the dough in the process of forming dough tortillas before pressing and cooking in an oven. For example, U.S. Pat. No. 4,668,524 discloses an apparatus and method for loading and precisely positioning dough balls onto a flat conveyor belt. The loading unit also forms a flat surface on the bottom of each of the dough balls, forcing the dough ball to stick to the conveyor belt. The loading machine prevents any rolling or other movement of the dough ball on the belt, and maintains a predefined uniform spacing between dough balls on the conveyor belt at all posterior processing stages. The aforementioned patent represents an improvement over the prior art of manually loading the dough balls in the press. However, when employing such machine, there are several steps to perform to flatten the dough balls. These steps include catching the balls at the closed bottom of the tapered tubes, sliding the press plate to deposit the balls on the transport belt, separating the pressing unit from the belt in an upward movement, closing the press plate, and lowering the pressing unit to flatten the dough balls against the transport belt. In this method of pre-shaping the dough balls, during the opening of the press plate some percentage of the balls slide easily on the top surface of the press plate and a small amount stick to the sliding press plate, due to the stickiness of the dough, generating a substantial off-register balls on the transport belt, and thus a considerable amount of discharged product waste. U.S. Pat. No. 5,396,833 describes a method and apparatus for processing dough. One of the included parts of the machine is a guide tube array mechanism, which deposits the balls in a desired array on a conveyor belt. Another of the included parts of the '833 patent, is a first pressing mechanism, which initially partially flattens the dough balls into thick disks for latter pressing them in the desired form. Even though precise positioning of the dough ball on the conveyor is achieved by this means, it relies on the random amount of time the dough ball takes to attain enough acceleration down the guide tube mechanism, to be flattened by its impact on the conveyor. On the other hand, U.S. Pat. No. 6,015,584 teaches a machine in which the spherical pieces of dough are pre-shaped by means of a device comprising a conveyor belt and a frame plate above the belt. Attached to the frame plate are first and second flatteners in a pivotal way. At least one of the flatteners has an actuator affixed to it, and each flattener has a bottom flat surface for flattening dough balls. The flatteners are pivoted from an open position wherein the bottom surface of each flattener is generally vertical, to a closed position wherein the preferably flat bottom surface of each flattener is substantially horizontal and parallel to the conveyor belt. Although an important improvement over prior art, during the opening of the press flatteners, an important percentage of the balls slide down easily on the transport band and a small amount of balls stick to the press flatteners, due to the stickiness of the dough. This generates a substantial member of off-register balls on the transport belt, and thus a considerable amount of discharged product waste. Another disadvantage of the pre-shaping machine described in U.S. Pat. No. 6,015,584, are the amount of mechanical steps required to flatten the dough balls. Although the claims in said patent disclose the press being always fixed in a relative position to the transport band, in practice, and in all commercial machines, the plate has to be moved relatively away and towards the transport belt during the pre-shaping procedure to allow the pre-shaped balls to transit without obstruction on the transport band and below the press plate.

### SUMMARY OF THE INVENTION

The present invention provides an automated means of pre-shaping dough balls in a high speed tortilla machine. Briefly, the machine comprises a main frame, a sub-frame, a set of press boxes, a set of press gates, a set of mechanical devices, and a set of catching ball tubes. The main frame contains a holding press plate with a set of regularly distributed openings, and where each press box is located over said regular openings. Each press box contains a catching ball tube, and a press gate actuated by mechanical means. After proofing each dough ball by means of devices known to those skilled in the art, in an initial short period of time, they are sequentially deposited onto the pre-shaper catching ball tubes to permit balls to pass through the open press gates and onto the surface of the transport band, where they are kept in a predetermined position. Once all of the dough balls reach said predetermined location, in a second short period of time, the dough balls are pre-pressed in place by means of a set mechanically actuated press gates. Additionally, and during the same second period of time, the flattener press gates close the ball entrance in the catching ball tubes, to prevent dough balls entering any further into the press boxes. In a third sequential short period of time, and before the main press period ends, the press gate devices are actuated to open the catching ball tube and separate the pressing gate device in an upward movement from the pre-pressed balls. During the same third period of time, the transport band advances the pre-pressed balls towards the main press area. In a further fourth short period of time, and before the main pressing period concludes, the main frame lowers its position, by mechanical means, towards the transport band to position itself the same relative distance from the transport band as marked in the initial short period of time. At this moment, the main press period of time concludes and the pre-shaping process repeats itself.

It is accordingly a principal objective of the present invention to provide an improved means to pre-shape dough balls in an automated tortilla machine. A further object of the present invention is to provide a means to pre-shape dough balls and to locate them in a precise position on the transportation band of an automated tortilla machine. Yet another object of the present invention is to provide a tortilla pre-shaping machine that can be used to precisely position the pre-shaped dough balls and avoid a surplus of mechanical steps thereby speeding up the tortilla production in automated machines. Yet, another object of the present invention is to provide a tortilla pre-shaping machine that can quickly produce a number of differently size tortilla pre-shaped dough balls. Still, another object of the present invention is to provide a tortilla pre-shaping machine that uses only two pairs of actuators to conform all the steps required to achieve such purpose.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a complete isometric view of the pre-shaper device showing the main frame, a press plate, a set of press boxes, a set of mechanical devices, a set of press gates, a set of catching ball tubes, a set of drop ball tubes, and a transport band;

FIG. 2 depicts an elevation front view of the pre-shaper device;

FIGS. 3A to 3D show the pre-shaping mechanical sequence of this invention;

FIGS. 4A to 4C compare the time sequence of prior art and the present invention for pre-shaping dough balls.

### DESCRIPTION OF A PREFERRED EMBODIMENT

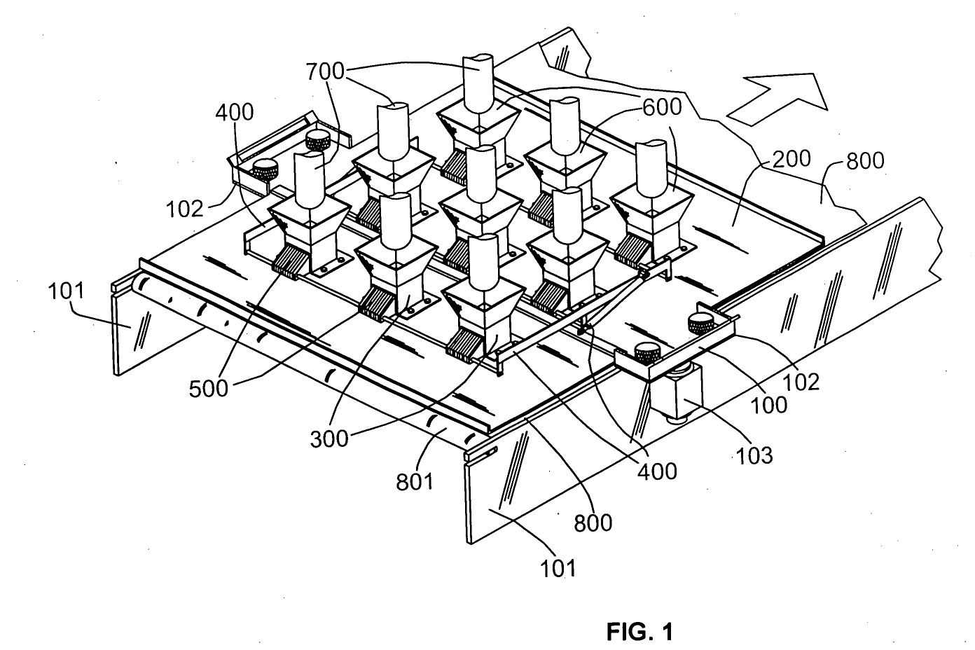

Referring now to the accompanying drawings, it will be seen that the main frame 100 of FIG. 1 consists of a pair of steel plates 101 separated in a parallel way and with enough separation between them to fix a cylindrical roller 801 wide enough to impart movement to a transport band 800. Attached to the same main frame is a sub-frame 200 with a set of regularly spaced round or rectangular perforations of dimensions that permit the dough ball to be pre-pressed to pass down into the transport band 800 without any interference. The dimensions of the sub-frame 200 are of sufficient size as to locate as many pre-selected set of dough balls as required in the pre-shape process, and with enough thickness as to mechanically withstand the shear and stress load forces which occur during the pre-shaping process. In a preferred embodiment, a rectangular steel plate of 40 by 40 inches and ¼ of an inch thickness is selected. The plate is firmly secured on its two lateral sides by a set of steel square bars 102 attached to a set of mechanical devices 103, to permit the main frame to move in an upward and downward displacement relative to the plane of the transport band 800. In a preferred embodiment the mechanical devices 103 are a pair of air pistons mechanically attached to the steel plates 101, and secured in a fixed position from their main body. The devices 103 elevate the square bars 102, by means of compressed air in the cylindrical pistons which, in turn, separate the sub-frame 200 away from the transport band 800 during one of various steps required in the pre-pressing cycle of the balls.

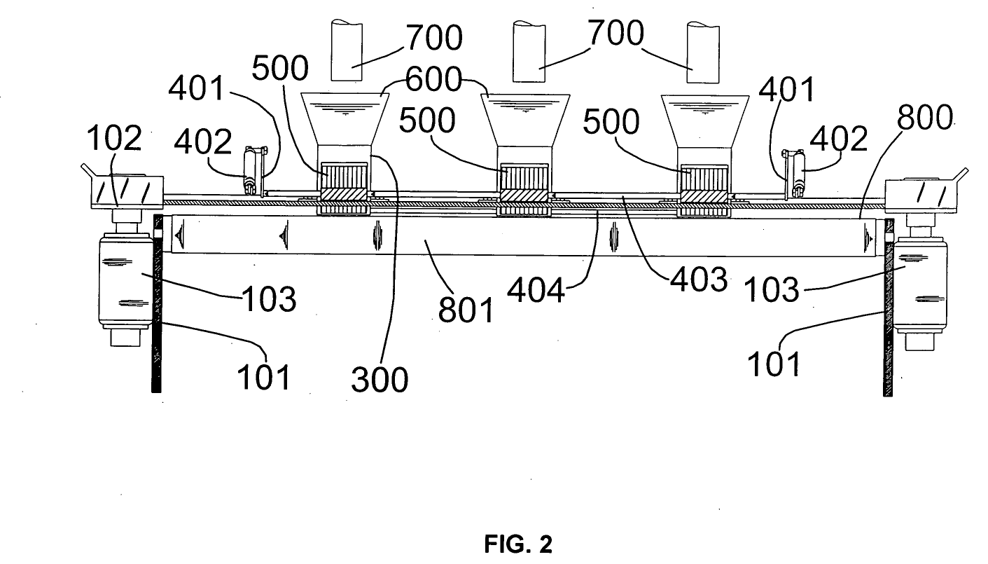

The sub-frame 200 also contains a set of press boxes 300 mechanically fixed over the sub-frame 200 perforations, and adjusted to fit tight on said perforations. In a preferred embodiment, nine press boxes are fixed over the 3 inch by 3 inch square perforations of sub-frame 200. In another preferred embodiment of the invention, the base of press boxes are flush pass the thickness of the sub-frame about ½ inch, to hold a pair of through holes or pivotal hinges, on two of the box sides below the lower surface of the sub-frame 200. The mechanical devices 401, 402, 403, and 404 in FIG. 2 comprise the mechanical means to perform, during various steps of the pre-pressing cycle, the pre-shaping of dough balls steps. In a preferred embodiment, device 401 consists of a movable metallic plate frame having four through holes which serve as pivot hinges points and allow translating its position in a parallel plane constrained by devices 402, 403, and 404, which will become apparent in the following description.

Device 402 mechanically impairs a relative movement to the metallic plate 401. One extreme is connected mechanically to a vertical eyelet attached to sub-frame 200 by a metallic pin with a self lubricated plastic grommet, both serving as a pivot hinge; the other extreme is connected mechanically to one of the metallic plate pivot hinges by a metallic pin with a self lubricated plastic grommet. One extreme side of 402 is connected to sub-frame 200, and constrained to rotate only in an axis parallel to the rotation axis of roller 801. The other extreme side of 402 is connected to one of the through holes of metallic plate 401, allowed to translate spatially and rotate along said pivot hinge with its axis parallel to the rotation axis of roller 801. In another preferred embodiment of this invention, devices 402 consist of a pair of air pistons mechanically attached to devices 401 and 200. The device 402 elongates by letting compressed air into the cylindrical pistons which in turn imparts movement to device 401. Device 403 consists of a round bar rod running through perforations in a row set of press plates 500 and secured in both extremes to another pivot hinges of metallic plates 401. The devices 404 of the same FIG. 2 consist of round bar rods to assemble each to the through holes of press plates 500 and the pivot hinges on the press boxes 300, each located below the lower face of sub-frame 200, as to serve as a pivotal rotation axis of the press plates 500 in both, a clockwise and counterclockwise movement.

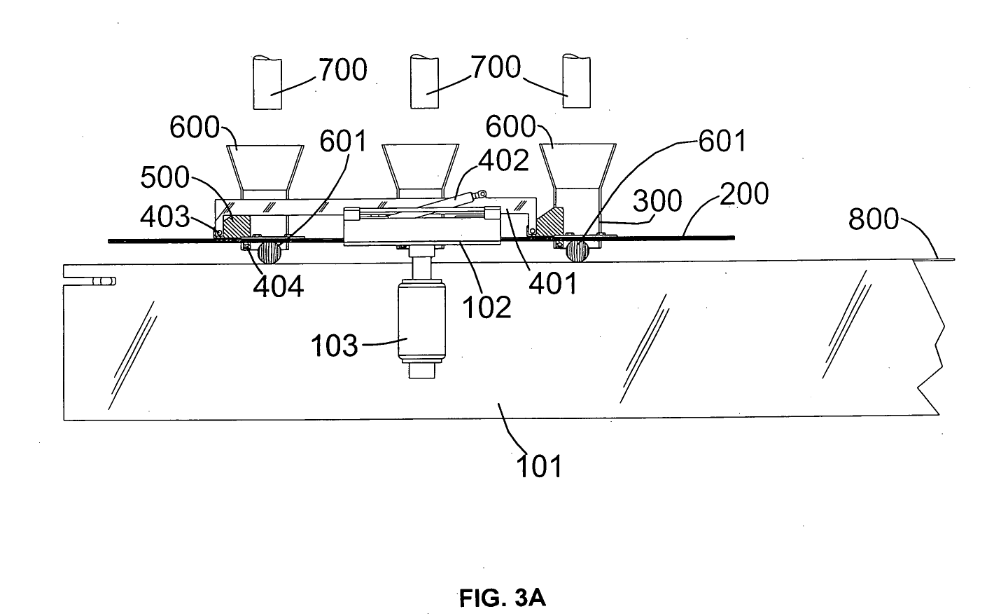

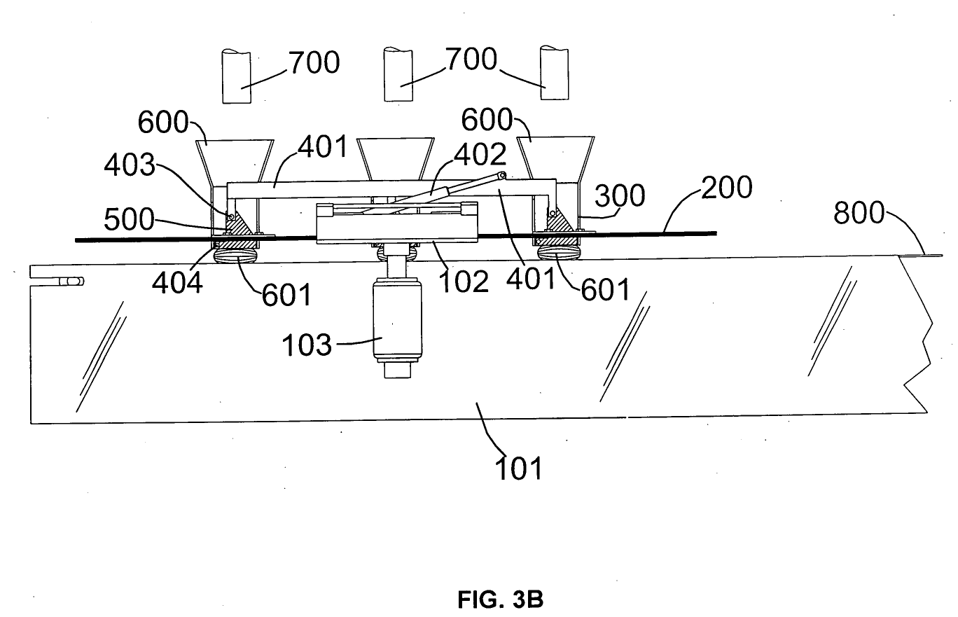

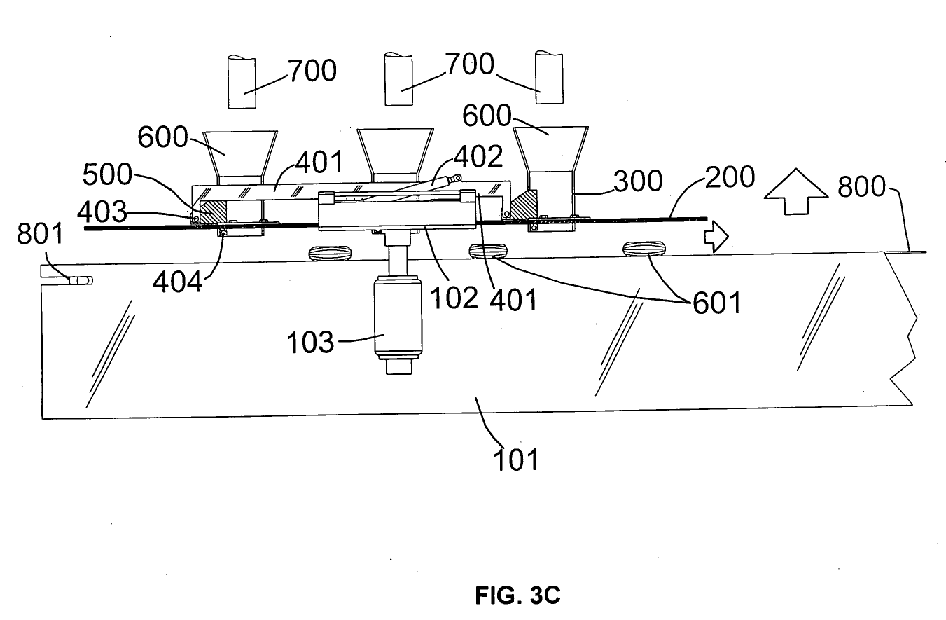

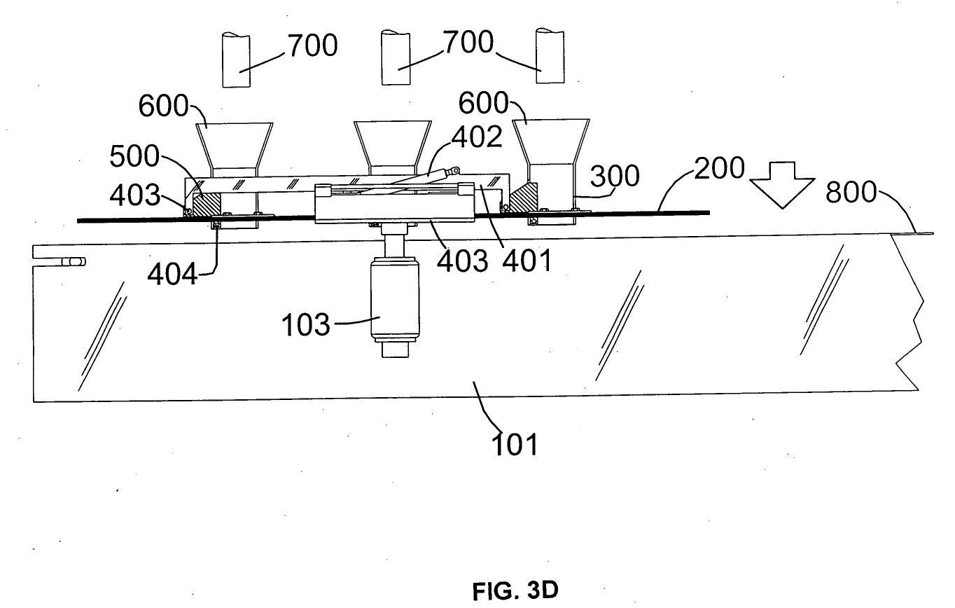

The cycle to pre-shape the dough balls is described in FIGS. 3A to 3D. In FIG. 3A is illustrated the start up condition of the pre-shaper. In an initial instant of time t1, the sub-frame 200 is located in its closest position to transport band 800, having the press plates 500 conveniently rotated counterclockwise to allow the dough balls drop down from the dough proffer device to a position on the surface of the stopped transport band 800. The fixed location of the press boxes on the sub-frame 200 assures that dough balls attain their final position before they are advanced to the main press area. In a preferred embodiment of this invention, for a 40 by 40 inch sub-frame plate, there are three press boxes separated in a row by 13 inches distance from center to center to any 600 next neighbor device. At the end of the first short period of time Δt1, a next ΔT1 period of time is allowed such that the whole mechanical devices in sub-frame 200 settle down to their stable position, whereas band 800 still maintains its stop condition.

Following, an illustrated in FIG. 3B, in another instant of time t2, devices 402 elongate their rod by applying compressed air to their pistons, and impairing constrained spatial movement to devices 401. The pivot hinges of devices 404 and the spatial movement of 401 generate a clockwise rotation of press plates 500, with help of rod 403, in the same rotation sense as to permit said plates to press the dough balls 601 against 800. At the end of the short period Δt2 of time, and in a following short period of time ΔT2, the mechanical devices of 200 are allowed to mechanically settle down to their stable positions. In another preferred embodiment of this invention, dough balls with a specific initial diameter are pre-pressed to one-half their original diameter to allow pre-pressed balls 601 to stick flat to transport band 800.

FIG. 3C shows the next mechanical scheme of the following pre-press stage. In a next short instant of time t3, devices 402 are allowed to contract their length to their original position described in FIG. 3A, and to impart an opposite spatial movement to 401. Pivot hinges of 401 allow press plates 500 to rotate counterclockwise to their original position as in FIG. 3A, releasing any mechanical contact of press plates faces 500 from the pre-pressed dough balls 601. At the same time of the short interval of time Δt3, devices 103 are allowed to actuate to elevate sub-frame 200 at such relative distance from transport band 800, as to allow pre-press flat bails 601 to transit on 800 without interference from 200. In the following short interval of time ΔT3, devices on 200 are allowed to mechanically settle down, and roll 801 is actuated to rotate by any mechanical means known in the art, to impart translation movement to 800 and the pre-pressed flat balls 601 towards a main press area of the machine.

In a preferred embodiment of the invention, devices 103 are commercial air driven pistons, able to elongate and contract rod length by actuating their elongation/contraction air valves. In a further preferred embodiment of the invention, mechanical actuators for the elevation or lowering of sub-frame 200 is carried out by a set of cam followers driven by mechanical means. FIG. 3D illustrates the last short period of time of the pre-press cycle of dough balls. At a further short instant of time t4, devices 103 are actuated to the contraction position by pressurized air to the piston rods, and imparting downward movement to sub-frame to the relative position as in FIG. 3A. Later, in the short interval of time ΔT4, all devices of pre-press sub-frame 200 are allowed to mechanically settle down. The period of ΔT4 ends the pre-pressing cycle.

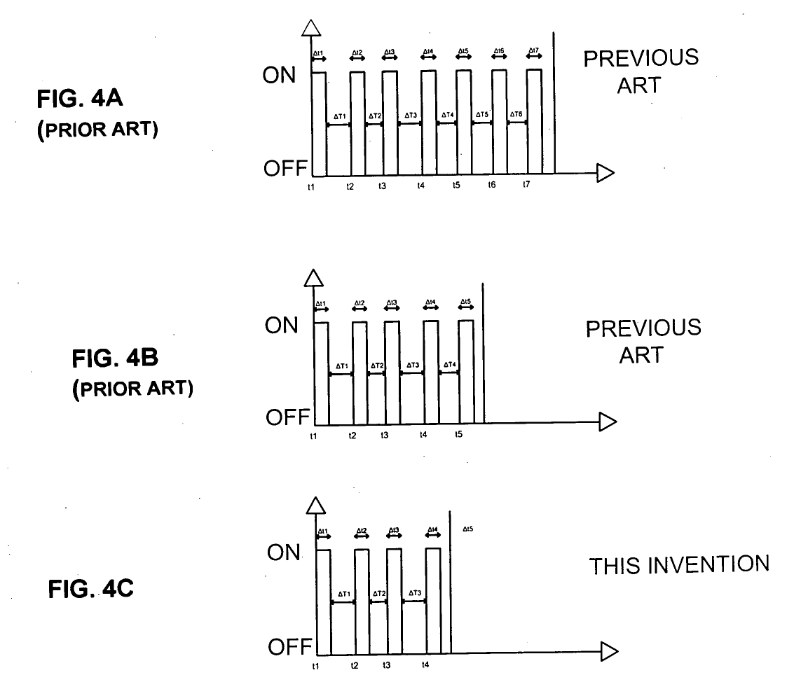

As a matter of comparison of the pre-pressing cycles required in prior art machines, FIGS. 4A and 4B show schematically the pre-pressing instants of time and periods of time required to implement said prior art pre-pressing machines. FIG. 4C illustrates the shorter pre-press cycle improvement attained in this invention, as compared to said prior art.

While considerable emphasis has been placed on the preferred embodiment of the invention illustrated and described herein, it will be appreciated that other embodiments are contemplated and that many changes can be made in the preferred embodiment without departing from the principal features of the invention. Accordingly, it will be understood that the foregoing description is to be interpreted merely as illustrative of the invention and not as a limitation of scope.

I claim:

1. An apparatus for pre-shaping dough balls and comprising a main frame to hold acting devices to press flat dough balls against a transport band, said main frame having a sub-frame plate with distributed openings to hold a set of press boxes, a set of press gates, a set of mechanical devices, and a transport band.

2. The apparatus of claim 1, wherein said sub-frame is held to said main frame by a pair of mechanical actuators fixed to said main frame to perform a parallel movement, away and towards said transport band during a pre-press cycle of the apparatus.

3. The apparatus of claim 1, wherein each said press box contains a catching ball tube opening, a hinged press gate, an acting circular rod handle, and a bottom face opening, said press boxes being located, and mechanically held fixed, on said openings, wherein each said press box contains said press gate mechanically held by means of a cylindrical pivot hinge pin, said pin running across a parallel face of said press box and securely welded to two opposite faces of said press box.

4. The apparatus of claim 1, comprising a first pair of mechanical devices having two rectangular flat bars with a distributed set of perforations along the largest length of said flat bars, said perforations serving as pivot hinges in connection to said press gates.

5. The apparatus of claim 4, comprising a second pair of mechanical devices having two air driven pistons having cylindrical bodies connected each to a pair of pivot hinges eyelets attached firmly to said sub-frame, and connected to a pivot hinge of said first pair of mechanical devices.

6. The apparatus of claim 1, comprising a third pair of mechanical devices having two air driven pistons each having a cylindrical body connected each to said main frame, wherein said piston is oriented so that a piston rod actuates in a direction perpendicular to the plane of said transport band.

7. The apparatus of claim 1, comprising a pair of parallel lateral plates mechanically fixed, lengthwise to said main frame, said plates being positioned vertically and separated by a counter plate mechanically attached to the widest face of said lateral plates, said set of plates forming a rigid rectangular, and horizontally positioned structure, said horizontal structure having a pair of cylindrical rollers located at ends of said parallel plates, and held by roller bearings, said cylindrical rollers being mechanically driven and attached to said main frame, said band being a high temperature type and being mounted on said rollers to convey continuously in a direction perpendicular to said rolls, and below said press plate, said band conveying across the pre-pressing and main pressing areas of a tortilla pressing machine.
